(19) United States
(12) Patent Application Publication
(10) Pub. No.: US 2012/0015181 A1
(43) Pub. Date: Jan. 19, 2012

(54) SUBSTRATE FOR FLEXIBLE DISPLAY AND MANUFACTURING METHOD THEREOF

(75) Inventors: Sang-Joon Seo, Yongin-city (KR); Hoon-Kee Min, Yongin-city (KR); Seung-Hun Kim, Yongin-city (KR); Sung-Guk An, Yongin-city (KR); Jung-Ha Lee, Yongin-city (KR)

(73) Assignee: SAMSUNG MOBILE DISPLAY CO., LTD., Yongin-city (KR)

(21) Appl. No.: 13/168,159

(22) Filed: Jun. 24, 2011

(30) Foreign Application Priority Data
Jul. 16, 2010 (KR) 10-2010-0069172

(51) Int. Cl. B32B 15/08; B32B 15/09; H05H 1/24

(52) U.S. Cl. 428/339; 427/569; 428/457; 428/412; 428/463; 428/458; 428/464

(57) ABSTRACT

A substrate for a flexible display and a manufacturing method thereof are disclosed. The substrate is thin and has a low oxygen and moisture transmittance. The substrate includes a plastic substrate and a barrier layer formed on the plastic substrate and having a density gradient in which a content of a metal increases toward the plastic substrate and a content of oxygen increases away from the plastic substrate.

### CROSS-REFERENCE TO RELATED APPLICATIONS

This application claims the benefit of Korean Patent Application No. 10-2010-0069172, filed on Jul. 16, 2010, in the Korean Intellectual Property Office, the disclosure of which is incorporated herein in its entirety by reference.

### BACKGROUND

1. Field

The present disclosure relates to a substrate for a flexible display and a manufacturing method thereof.

2. Description of the Related Technology

Liquid crystal display devices and organic light emitting display devices are widespread in the market for displays for mobile devices such as digital cameras, video cameras, personal digital assistants (PDAs), cellular phones, and the like. Displays for mobile devices are typically thin, light, and unbreakable. To achieve such characteristics, instead of a method using a thin glass substrate, a method of forming a typical glass substrate and then mechanically or chemically thinning the glass substrate may be adopted. However, such a method may be complicated and the thinned glass substrate may be easily breakable.

Displays for mobile devices are also typically required to be portable and flexible, in order to be used in various-shaped display devices. However, a typical glass substrate is not flexible. As such, manufacturing of a display device using a plastic substrate has been attempted. However, a plastic substrate may have a high moisture and oxygen transmittance and may be vulnerable to high-temperature processes.

### SUMMARY OF CERTAIN INVENTIVE ASPECTS

Embodiments provide a substrate for a flexible display, the substrate including a thin barrier layer having no characteristic change even at a high temperature and having excellent oxygen and moisture blocking characteristics, and a manufacturing method of the substrate.

Embodiments also provide a substrate for a flexible display, the substrate having a simple manufacturing process, capable of reducing manufacturing cost and time, and allowing mass production, and a manufacturing method of the substrate. One aspect is a substrate for a flexible display, the substrate including: a plastic substrate, and a barrier layer formed on the plastic substrate and having a density gradient in which a content of a metal increases toward the plastic substrate and a content of oxygen increases away from the plastic substrate.

Another aspect is a method of manufacturing a substrate for a flexible display, the method including: providing a plastic substrate, and forming, on the plastic substrate, a barrier layer including a density gradient layer, where a content of a metal increases toward the plastic substrate and a content of oxygen increases away from the plastic substrate in the density gradient layer.

### BRIEF DESCRIPTION OF THE DRAWINGS

The above and other features and advantages will become more apparent by describing in detail certain embodiments with reference to the attached drawings in which:

FIG. 1 is a cross-sectional view of an embodiment of a substrate for a flexible display;

FIG. 2 is a graph showing contents of oxygen and metal in a barrier layer of the embodiment of a substrate illustrated in FIG. 1;

FIG. 3 is a cross-sectional view of another embodiment of a substrate for flexible displays;

FIG. 4 is a cross-sectional view of another embodiment of a substrate for flexible displays;

FIGS. 5 through 11 are cross-sectional views for describing an embodiment of a manufacturing method of the embodiment of a substrate illustrated in FIG. 3; and

FIG. 12 is a cross-sectional view of an embodiment of an organic electroluminescence display device using an embodiment of the substrate illustrated in FIGS. 1, 3, or 4.

### DETAILED DESCRIPTION OF CERTAIN INVENTIVE EMBODIMENTS

Hereinafter, embodiments will be described in detail with reference to the attached drawings.

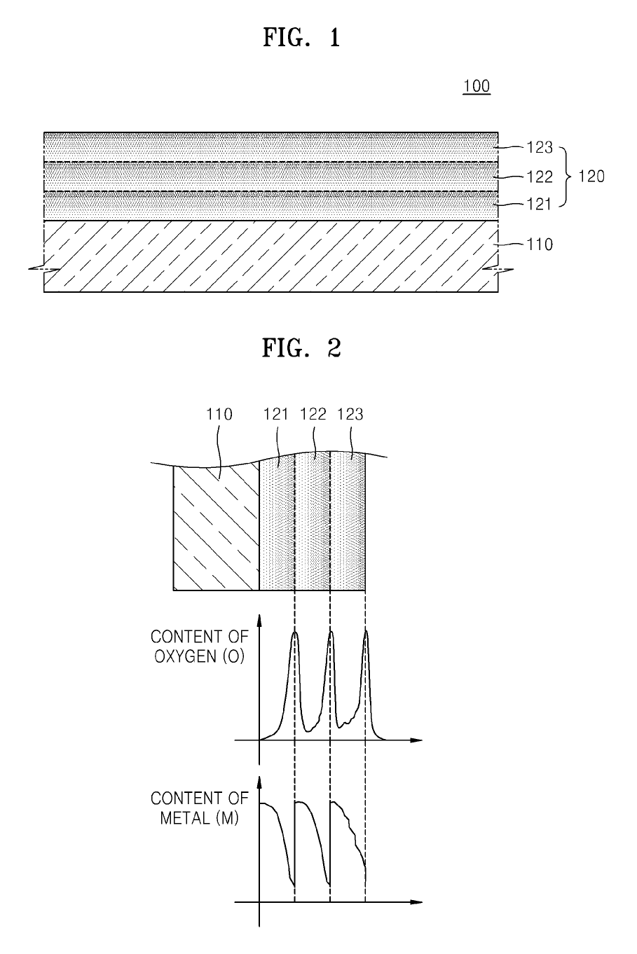

FIG. 1 is a cross-sectional view of an embodiment of a substrate 100 for a flexible display. FIG. 2 is a graph showing contents of oxygen, O, and metal, M, in a barrier layer 120 of the substrate 100 illustrated in FIG. 1.

Referring to FIGS. 1 and 2, the substrate 100 includes a plastic substrate 110 and the barrier layer 120 formed on the plastic substrate 110.

In some embodiments, the plastic substrate 110 may be formed of a flexible material to realize a flexible display. In other embodiments, the plastic substrate 110 may be in the form of a thin film.

The plastic substrate 110 may be formed of a material having a transition temperature between about 350° C. and about 500° C., so that the plastic substrate 110 may function without being deformed even when the barrier layer 120, a thin film transistor (TFT), and other electronic elements are formed on the plastic substrate 110 at a high temperature. As described below, the barrier layer 120 may be formed at a temperature between about 350° C. and about 500° C.

The plastic substrate 110 may contain a polymer having a high heat resistance. In some embodiments, the plastic substrate 110 may contain a material selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide (PI), polycarbonate (PC), cellulose triacetate, cellulose acetate propionate (CAP), poly(arylene ether sulfone), and mixtures thereof

PI generally has good mechanical strength, good heat resistance and a transition temperature of about 450° C. Accordingly, in embodiments where PI is used, while the barrier layer 120 is formed, the plastic substrate 110 may appropriately function as a substrate without being sagged down.

The barrier layer 120 is formed on the plastic substrate 110 to block transmittance of oxygen and moisture through the plastic substrate 110. Typically, the plastic substrate 110 has a high oxygen and moisture transmittance. If a TFT or other electronic elements are formed directly on the plastic substrate 110, oxygen and moisture transmitted through the plastic substrate 110 may greatly reduce the lifespan of a display formed by using the plastic substrate 110. The barrier layer 120 helps to block oxygen and moisture to protect the TFT and the other electronic elements, and also helps to prevent deterioration of the display.

The barrier layer 120 has a density gradient in which the content of metal M increases toward the plastic substrate 110 and the content of oxygen O increases away from the plastic substrate 110.

Referring to FIG. 1, the barrier layer 120 includes a plurality of density gradient layers. In some embodiments, there are, first through third density gradient layers 121 through 123.

Referring to FIG. 2, the content of oxygen O in each of the first through third density gradient layers 121 through 123 decreases toward the plastic substrate 110 and increases away from the plastic substrate 110. Accordingly, the content of oxygen O in the barrier layer 120 gradually increases and then decreases in a repeated pattern away from the plastic substrate 110.

The content of metal M in each of the first through third density gradient layers 121 through 123 increases toward the plastic substrate 110 and decreases away from the plastic substrate 110. Accordingly, the content of metal M in the barrier layer 120 gradually decreases and then increases in a repeated pattern away from the plastic substrate 110.

The metal M contained in the barrier layer 120 may contain a material selected from the group consisting of aluminum (Al), copper (Cu), calcium (Ca), titanium (Ti), silicon (Si), barium (Ba), and mixtures thereof. In embodiments where the barrier layer 120 includes the first through third density gradient layers 121 through 123, in order to simplify a manufacturing process and to obtain stable interfaces between the first through third density gradient layers 121 through 123, the first through third density gradient layers 121 through 123 may contain the same material for metal M.

The content of oxygen O in each of the first through third density gradient layers 121 through 123 included in the barrier layer 120 may be increased by depositing the metal M on the plastic substrate 110 and exposing the plastic substrate 110, on which the metal M is deposited, to an oxidation atmosphere. In some embodiments, the metal M may be exposed to oxygen plasma to increase the content of oxygen O on a surface of the metal M.

Since the first through third density gradient layers 121 through 123 formed as described above do not have abrupt boundaries therebetween, the possibility that defects and cracks occur may be greatly reduced in comparison to a typical barrier layer formed by alternately depositing a metal layer and an inorganic layer.

In a typical barrier layer, due to an uneven surface of the deposited metal layer, the inorganic layer may have defects and cracks, and thus oxygen and moisture may not be sufficiently blocked. The oxygen and moisture transmittance of the typical barrier layer is about 10⁻² g/m²/day. However, the first through third density gradient layers 121 through 123 have even surfaces, and thus occurrence of defects and cracks is greatly reduced. Accordingly, the oxygen and moisture transmittance of the barrier layer 120 in certain embodiments is reduced to about 10⁻⁴ g/m²/day.

Also, the total thickness of the barrier layer 120 may be reduced in comparison to the typical barrier layer thickness.

The barrier layer 120 may have a thickness of about 1 nm to about 10 μm. In some embodiments, the barrier layer 120 may have a thickness of about 0.3 μm to about 0.5 μm.

In some embodiments, the barrier layer 120 may include two density gradient layers, e.g., the first and second density gradient layers 121 and 122. In other embodiments, the barrier layer 120 may include one density gradient layer, e.g., the first density gradient layer 121, as illustrated in FIG. 4. In yet other embodiments, the barrier layer 120 may include four or more density gradient layers.

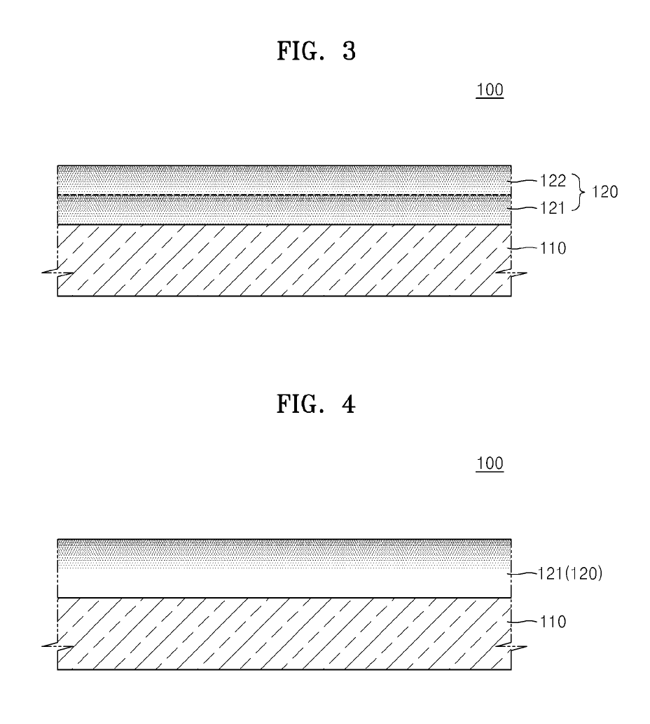

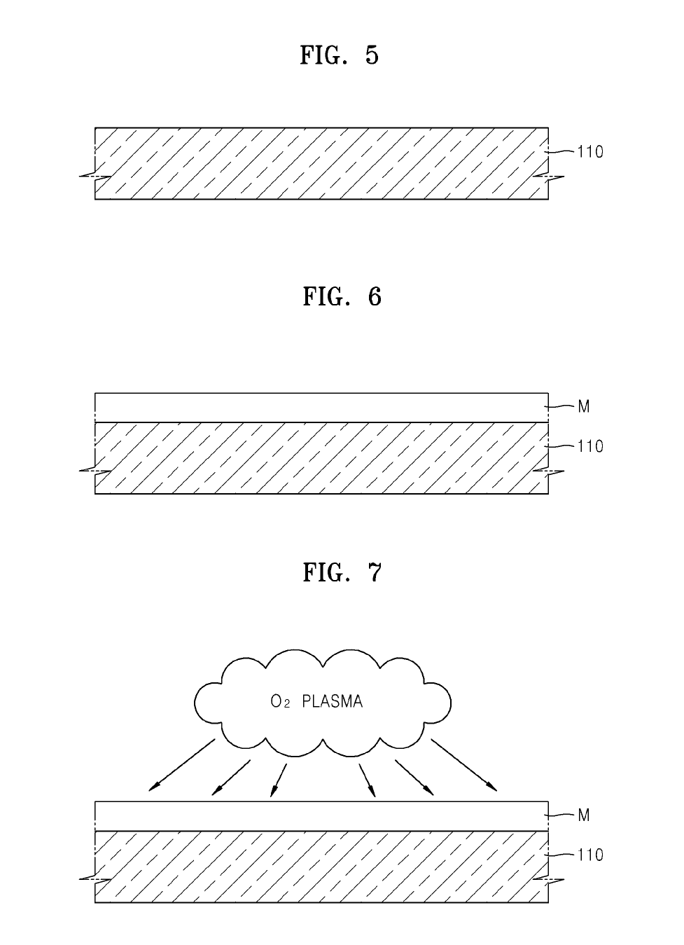

An embodiment of a manufacturing method of the substrate 100 will now be described. FIGS. 5 through 11 are cross-sectional views for describing an embodiment of a manufacturing method of the substrate 100 illustrated in FIG. 3.

Referring to FIG. 5, the plastic substrate 110 is provided. In some embodiments, the plastic substrate may be a thin film.

The plastic substrate 110 may be formed of a material having a transition temperature between about 350° C. and about 500° C., so as not to be deformed in a high-temperature process to be described below.

Referring to FIG. 6, the metal M is deposited on the plastic substrate 110.

The metal M may be formed of a material selected from the group consisting of Al, Cu, Ca, Ti, Si, Ba, and mixtures thereof. In some embodiments, the metal M deposited on the plastic substrate 110 may be a thin film.

In some embodiments, the metal M may be deposited by using a sputtering method. The sputtering method may be non-restrictively performed as described below. The plastic substrate 110 is put into a chamber, and then atoms are physically sputtered by colliding high-energy particles with a high-purity solid plate of the metal M. The sputtered atoms may then be moved to and deposited on the plastic substrate 110 in a vacuum environment.

In other embodiments, the metal M may be deposited by using a physical vapor deposition (PVD) method, such as a thermal evaporation method, or by using a chemical vapor deposition (CVD) method, such as a low pressure chemical vapor deposition (LPCVD) method.

Referring to FIG. 7, the plastic substrate 110 on which the metal M is deposited is exposed to an oxidation atmosphere. In some embodiments, the oxidation atmosphere may be oxygen plasma.

The oxygen plasma may be non-restrictively generated as described below. The plastic substrate 110 on which the metal M is deposited is put into a radio-frequency (RF) plasma reactor, a vacuum environment is generated by using a vacuum pump, and the vacuum state is maintained for a predetermined period of time. Oxygen is injected into the RF plasma reactor and then an RF output is set by using an RF generator and adjustor, thereby generating the oxygen plasma.

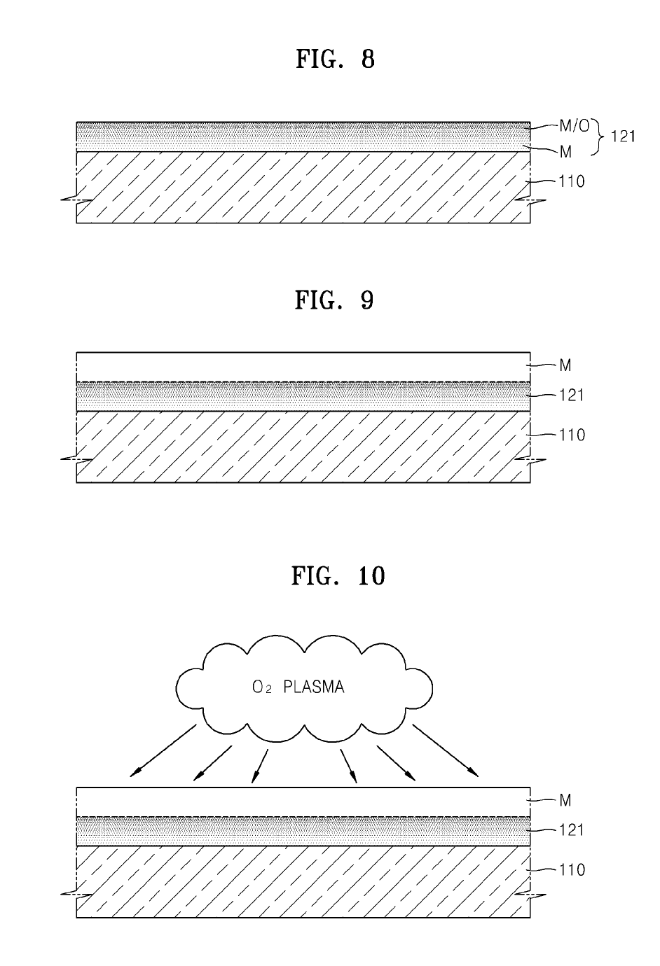

Referring to FIG. 8, a surface of the metal M deposited on the plastic substrate 110 is oxidized due to the oxygen plasma, the content of oxygen O is increased, and thus the first density gradient layer 121 is formed.

Referring to FIG. 9, the metal M is deposited on the first density gradient layer 121. The metal M may be deposited by using the sputtering method as described above in relation to FIG. 6, and the material for metal M may be the same as the metal M contained in the first density gradient layer 121. In other embodiments, the material for metal M may be different than the material for metal M contained in the first density gradient layer 121.

Referring to FIG. 10, the metal M deposited on the first density gradient layer 121 is exposed to an oxidation atmosphere. The oxidation atmosphere may be the oxygen plasma described above in relation to FIG. 7.

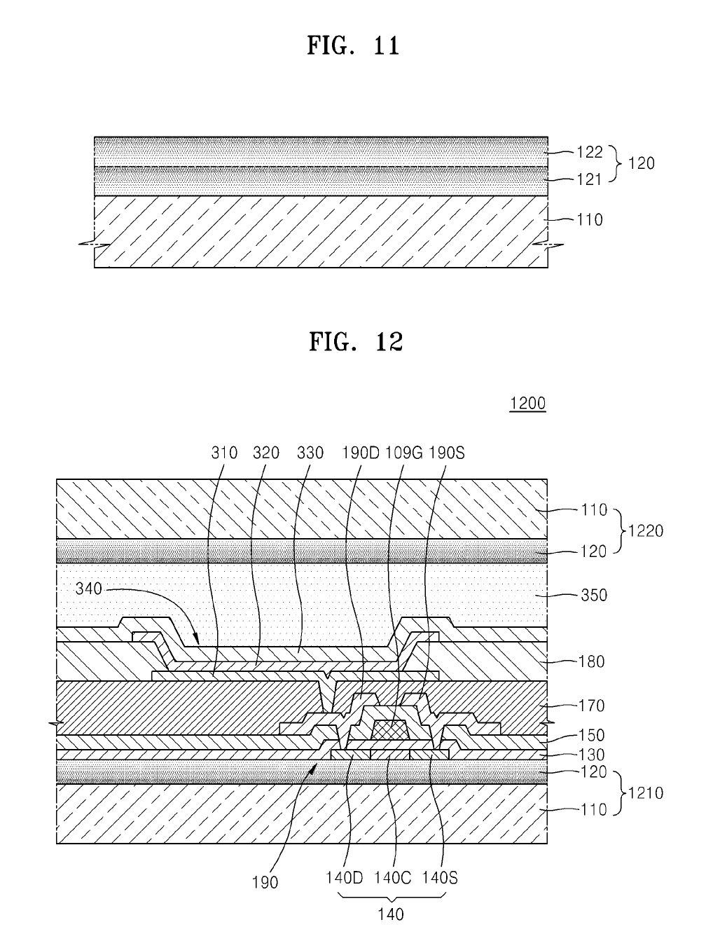

Referring to FIG. 11, a surface of the metal M deposited on the first density gradient layer 121 is oxidized due to the oxygen plasma, the content of oxygen O is increased, and thus the second density gradient layer 122 is formed.

As in the first density gradient layer 121, in the second density gradient layer 122, the content of metal M increases toward the plastic substrate 110 and the content of oxygen O increases away from the plastic substrate 110.

As the barrier layer 120 including the first and second density gradient layers 121 and 122 is formed on the plastic substrate 110, the content of oxygen O in the barrier layer 120 gradually increases, decreases, gradually increases again, and then decreases again away from the plastic substrate 110.

If the metal M is deposited on the second density gradient layer 122 and then is exposed to an oxidation atmosphere such as the oxygen plasma by using the method described above in relation to FIGS. 10 and 11, the third density gradient layer 123 may be further formed.

FIG. 12 is a cross-sectional view of an embodiment of an organic electroluminescence display device 1200 using an embodiment of the substrate 100 illustrated in FIGS. 1, 3, or 4,.

Referring to FIG. 12, the substrate 100 may be used as a substrate 1210 on which a TFT 190 and an encapsulation member 1220 are formed.

An active layer 140 of the TFT 190 is formed on the barrier layer 120 formed on the plastic substrate 110, and a gate insulating layer 130 is formed to cover the active layer 140 and the barrier layer 120. The active layer 140 includes a source region 140S, a drain region 140D, and a channel region 140C between the source and drain regions 140S and 140D. A gate 109G is formed on the gate insulating layer 130 above the channel region 140C. An interlayer insulating layer 150 is formed on the gate 109G and the gate insulating layer 130, a source electrode 190S and a drain electrode 190D are formed on the interlayer insulating layer 150, and a planarization layer 170 and a pixel defining layer 180 are formed to cover the source and drain electrodes 190S and 190D and the interlayer insulating layer 150.

A pixel electrode 310 of an organic light emitting element 340 is exposed through an opening of the pixel defining layer 180, and an organic light emitting layer 320 of the organic light emitting element 340 is formed on the pixel electrode 310. The pixel electrode 310 and a counter electrode 330 formed on the pixel electrode 320 are insulated from each other by the organic light emitting layer 320.

The encapsulation member 1220, like the substrate 1210, includes a plastic substrate 110 and a barrier layer 120 formed on the plastic substrate 110. As described above in relation to FIGS. 1 and 2, the barrier layer 120 may include a plurality of density gradient layers. The content of oxygen O in the barrier layer 120 gradually increases and then rapidly decreases in a repeated pattern from the plastic substrate 110 toward a filler 350. As described above in relation to FIGS. 1 and 2, the barrier layer 120 has a thickness of between about 0.3 μm to about 0.5 μm, and has a low oxygen and moisture transmittance of about 10⁻⁴ g/m²/day to sufficiently block oxygen and moisture.

One top-gate type TFT 190 is illustrated in FIG. 12. In other embodiments, the TFT 190 may be various types such as a bottom-gate type and one or more TFTs 190 may be formed.

In the embodiment of FIG. 12, the barrier layer 120 is formed in both the substrate 1210 and the encapsulation member 1220. In other embodiments, the barrier layer 120 may be formed on only one of the substrate 1210 and the encapsulation member 1220.

As described in the embodiments above, a surface roughness may be reduced and thus surface characteristics may be improved, and an inorganic layer may be appropriately formed in simple oxygen plasma.

A plurality of density gradient layers may be formed and the thickness of a barrier layer may be easily controlled according to exposure time of a metal to an oxidation atmosphere.

As such, the barrier layer may have a small thickness and may effectively block oxygen and moisture.

Characteristics of a substrate may not be changed even when exposed to a high temperature as in a process of forming a TFT, and the barrier layer may be stably formed by reducing stress applied to the substrate.

While the present invention has been particularly shown and described with reference to certain embodiments, it will be understood by those of ordinary skill in the art that various changes in form and details may be made therein without departing from the spirit and scope of the present invention as defined by the following claims.

What is claimed is:

1. A substrate for a flexible display, the substrate comprising:
a plastic substrate; and
a barrier layer formed on the plastic substrate and having a density gradient in which a content of a metal increases toward the plastic substrate and a content of oxygen increases away from the plastic substrate.

2. The substrate of claim 1, wherein the barrier layer comprises a plurality of density gradient layers, and
wherein the content of the metal in each of the plurality of density gradient layers increases toward the plastic substrate and decreases away from the plastic substrate.

3. The substrate of claim 2, wherein, in each of the plurality of density gradient layers, the content of the metal in the density gradient layer is inversely proportional to the content of oxygen in the density gradient layer.

4. The substrate of claim 2, wherein each of the plurality of density gradient layers comprises the same metal.

5. The substrate of claim 1, wherein the metal comprises a material selected from the group consisting of aluminum (Al), copper (Cu), calcium (Ca), titanium (Ti), silicon (Si), barium (Ba), and mixtures thereof.

6. The substrate of claim 1, wherein the plastic substrate has a transition temperature between about 350° C. and about 500° C.

7. The substrate of claim 1, wherein the plastic substrate comprises a material selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide (PI), polycarbonate (PC), cellulose triacetate, cellulose acetate propionate (CAP), poly(arylene ether sulfone), and mixtures thereof.

8. The substrate of claim 1, wherein the barrier layer has a thickness between about 1 nm and about 10 μm.

9. The substrate of claim 1, wherein the barrier layer has a thickness between about 0.3 μm and about 0.5 μm.

10. A method of manufacturing a substrate for a flexible display, the method comprising:
providing a plastic substrate; and
forming, on the plastic substrate, a barrier layer comprising a density gradient layer, wherein a content of a metal increases toward the plastic substrate and a content of oxygen increases away from the plastic substrate in the density gradient layer.

11. The method of claim 10, wherein forming of the barrier layer comprises:
depositing the metal on the plastic substrate; and
exposing a surface of the metal to an oxidation atmosphere.

12. The method of claim 11, wherein the exposing of the surface of the metal to the oxidation atmosphere comprises exposing to oxygen plasma.

13. The method of claim 10, wherein the plastic substrate has a transition temperature between about 350° C. and about 500° C.

14. The method of claim 10, wherein forming of the barrier layer comprises forming a plurality of density gradient layers, wherein each density gradient layer is formed by depositing the metal on a surface and exposing a surface of the metal to an oxidation atmosphere.

15. The method of claim 14, wherein, in each of the plurality of density gradient layers, the content of the metal in the density gradient layer is inversely proportional to the content of oxygen in the density gradient layer.

16. The method of claim 14, wherein the plurality of density gradient layers are formed depositing the same metal.

17. The method of claim 10, wherein the plastic substrate comprises a material selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide (PI), polycarbonate (PC), cellulose triacetate, cellulose acetate propionate (CAP), poly(arylene ether sulfone), and mixtures thereof.

18. The method of claim 10, wherein the barrier layer has a thickness between about 1 nm and about 10 μm.

19. The method of claim 10, wherein the barrier layer has a thickness between about 0.3 μm and about 0.5 μm.

20. The method of claim 10, wherein the metal comprises a material selected from the group consisting of aluminum (Al), copper (Cu), calcium (Ca), titanium (Ti), silicon (Si), barium (Ba), and mixtures thereof.
